(19) United States
(12) Patent Application Publication
(10) Pub. No.: US 2025/0199890 A1
(43) Pub. Date: Jun. 19, 2025

(54) Universal Core to Accelerator Communication Architecture

(71) Applicant: Intel Corporation, Santa Clara, CA (US)

(72) Inventors: Yipeng Wang, Portland, OR (US); Rajesh M. Sankaran, Portland, OR (US); Ren Wang, Portland, OR (US); Narayan Ranganathan, Bangalore (IN); Jr-Shian Tsai, Portland, OR (US); Tsung-Yuan Tai, Portland, OR (US); Heqing Zhu, Minhang District (CN); Ilia Kurakin, Nizhny Novgorod (RU); Binh Pham, Burlingame, CA (US); Halit Dogan, Westborough, MA (US)

(73) Assignee: Intel Corporation, Santa Clara, CA (US)

(21) Appl. No.: 18/846,403

(22) PCT Filed: Mar. 15, 2022
(86) PCT No.: PCT/CN2022/080895

§ 371 Date: Sep. 12, 2024

(51) Int. Cl. G06F 9/54; G06F 9/30; G06F 12/0873; G06F 13/28

(52) U.S. Cl. CPC G06F 9/544; G06F 9/30047; G06F 12/0873; G06F 13/28

(57) ABSTRACT

Methods and apparatus relating to a universal core to accelerator communication architecture for enhanced performance and/or programmability are described. In an embodiment, a sending agent is coupled to a processor core and a receiving agent is coupled to a hardware accelerator device. Memory store data corresponding to a request from the processor core. The sending agent and the receiving agent maintain a communication channel to facilitate communication between the processor core and the hardware accelerator device in response to the request. Other embodiments are also disclosed and claimed.

### FIELD OF THE INVENTION

The present disclosure generally relates to the field of computer processors. More particularly, an embodiment relates to a universal core to accelerator communication architecture for enhanced performance and/or programmability.

### BACKGROUND OF THE INVENTION

Some on-chip accelerators may communicate through a combination of techniques including Memory Mapped Input/Output (MMIO) read/write operations, device Direct Memory Access (DMA) read/write, and/or interrupt/polling operations. Such approaches can cause multiple inefficiencies during communication, such as a slow MMIO write speed, shared queue management overhead (e.g., due to dynamic request batch size and/or head/tail updates), out-of-order execution and Quality of Service (QOS) issues, cache line bouncing (where a cache line is unnecessarily moved across multiple caches), etc.

Hence, on-chip accelerators would operate more efficiently if such communication issues were sufficiently addressed.

### BRIEF DESCRIPTION OF DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a comparative block diagram of communication models in accordance with some embodiments.

FIG. 2 illustrates a block diagram of a core to accelerator communication architecture, according to an embodiment.

FIGS. 3A and 3B illustrate block diagrams of a hardware architecture for a core to accelerator communication architecture, according to some embodiments.

FIGS. 4A and 4B illustrate flow diagrams according to some embodiments.

FIG. 5 illustrates a sample pseudo code 500 for implementing a core to accelerator communication architecture, according to an embodiment.

FIG. 6A is a block diagram illustrating both an exemplary in-order pipeline and an exemplary register renaming, out-of-order issue/execution pipeline according to embodiments.

FIG. 6B is a block diagram illustrating both an exemplary embodiment of an in-order architecture core and an exemplary register renaming, out-of-order issue/execution architecture core to be included in a processor according to embodiments.

FIG. 7 illustrates a block diagram of an SOC (System On Chip) package in accordance with an embodiment.

FIG. 8 is a block diagram of a processing system, according to an embodiment.

FIG. 9 is a block diagram of an embodiment of a processor having one or more processor cores, according to some embodiments.

FIG. 10 is a block diagram of a graphics processor, according to an embodiment.

### DETAILED DESCRIPTION OF THE INVENTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware (such as logic circuitry or more generally circuitry or circuit), software, firmware, or some combination thereof.

As mentioned above, some on-chip accelerators (such as Data Streaming Accelerator (DSA), Intel® Analytics Accelerator (IAX), and Dynamic Load Balancer (DLB), provided by Intel® Corporation of Santa Clara, California) communicate through a combination of techniques including Memory Mapped Input/Output (MMIO) read/write operations, device Direct Memory Access (DMA) read/write, and/or interrupt/mwait/polling operations. As discussed herein, “mwait” generally refers to a hint that allows a processor to stop instruction execution and enter an implementation-dependent optimized state until occurrence of a class of events used to wake up the processor based on a memory location. Such approaches can cause multiple inefficiencies during communication, such as a slow MMIO write speed, shared queue management overhead (e.g., due to dynamic request batch sizes), out-of-order execution and Quality of Service (QOS) issues, cache line bouncing, etc.

Moreover, a relatively recently introduced Accelerator Interfacing Architecture (AIA) instruction set by Intel Corporation (e.g., including MOVDIR64B and ENQCMD instructions) is aimed at improving the MMIO write speed. Although AIA supports efficient job dispatch, synchronization, and signaling for accelerators, this instruction set does not appear to solve all higher level software overhead problems, such as queue management and/or dynamic request batching, QoS and out-of-order requirements, etc. Additionally, it can also be difficult for even experienced programmers to tune and develop highly efficient drivers and applications to take full advantage of hardware accelerators. There is also no universal communication architecture or implementation for accelerator communication, i.e., where different hardware accelerators and drivers may be implemented differently depending on the hardware and software developers. Lack of a universal communication solution for accelerators leads to duplicated implementation efforts and unexpected bugs.

To this end, some embodiments provide a universal core to accelerator communication architecture for enhanced performance and/or programmability. In an embodiment, a hardware-assisted approach to unify and simplify driver and application development is provided to take advantage of hardware accelerators. With the simplified software, a significant amount of Central Processing Unit (CPU) or processor cycles can be saved for other valuable work.

By contrast, a combination of established low-level communication techniques may be used for core to accelerator communication. These may involve MMIO read/write using direct store, DMA read/write by the accelerator, and interrupt/polling/mwait based result querying. However, a driver or application still needs to be designed to use these low-level methods to communicate with an accelerator efficiently. Even with such techniques, the direct stores may be strongly ordered with respect to other direct stores to the same address. Since the direct store targets the limited MMIO addresses from the accelerator to submit jobs, those MMIO writes could be serialized and slow down the processor core backend. Moreover, batching can be used for optimization to reduce such overhead. Performing software batching may require high level application involvement to balance between latency and throughput. As a result, these issues complicate the driver and application design and programming efforts.

Moreover, some existing software-based communication solutions may use a significant number of CPU cycles. For example, for a driver that is driving an on-chip accelerator, over thirty cycles may be spent in CPU only to offload one request. Reducing CPU overhead creates an opportunity for accelerating sub-100 cycle tasks such as memory allocation, data serialization/deserialization, etc.

In some embodiments, a core to accelerator communication architecture (sometimes referred to as “ACRE”) utilizes a hardware-based approach to unify and simplify the core to accelerator communication interface. ACRE includes a sending agent and a receiving agent. These agents are, in turn, responsible for generating one or more communication channels between a core and an accelerator, as well as exchanging any requisite messages between the core and accelerator without software involvement. Accordingly, ACRE can offload the software management of the communication channel(s) to the hardware agents, removing software overhead and complexities from the CPU core.

In an embodiment, ACRE creates and maintains core-to-accelerator communication channel(s) in hardware. Some advantages include: (1) exposing less low-level hardware specifics to software, and unifying interface and reducing programming effort; (2) reducing core pipeline overhead, leaving more cycles to be available for other useful work; and/or (3) additional features, such as QoS or dynamic batching, can be realized in hardware by monitoring hardware events.

By contrast, to take advantage of an on-chip accelerator, applications can choose to use user-space drivers to send (e.g., 64-Byte) job descriptors either by a shared descriptor ring-buffer, or directly MMIO the job descriptor into the accelerator's incoming buffer. If a shared ring-buffer is used, a batch descriptor or “doorbell” is MMIO written to the accelerator to notify the batch of job descriptors. Then, the accelerator DMA reads the single job descriptors from the ring-buffer. For result querying, software may poll a flag bit in a completion record which is written by the accelerator after finishing the job (e.g., using a DSA driver). Software then can read the results from the completion record and perform post-processing if necessary. To work with the driver, upper-level applications need to be changed to call the Application Programming Interface(s) (API(s)) correctly. For example, a driver may provide three APIs including: Enqueue_op ( ) which enqueues a job into a shared ring buffer; Perform_ops ( ) which will MMIO a batch descriptor into an accelerator describing the previously enqueued jobs; and Completed_ops ( ) which will check completed results from the accelerator. It is up to the application to call each of the APIs in a pipelined fashion to get optimal throughput-latency trade-off.

In such communication methods, software maintains the communication channels in shared memory, and sends batch descriptors to accelerators using MMIO write (i.e., using direct stores like MOVDIR64B or regular stores to write to the MMIO address of the accelerator port). It is up to the driver and application developer to decide when and how to batch the requests and how to maintain the ring buffer (or another data structure, if more efficient). There are two issues with such method. These issues could prevent many computing systems from adopting hardware accelerators.

First, driver and application maintenance efforts are high. It is generally not easy to develop highly efficient drivers and rewrite the applications to use the drivers and maintain the drivers and applications across different hardware generations. The complexity of software development mainly comes from three aspects:
(1) the asynchronous communication model requires software to asynchronously check results and submit jobs. This requires careful software pipelining design to overlap CPU processing with accelerator processing.
(2) Even with an AlA instruction, software needs to dynamically evaluate batching size to trade-off between throughput and latency. Smaller batch sizes could cause larger amounts of serialized MMIO writes, but larger batches could cause extra queueing latency in the software queue. This requires software to make dynamic decisions based on platform performance insights which is not easy to obtain.
(3) In a multi-tenant environment where software submits jobs using ENQCMD instructions, a retry signal is returned to software and software needs to make intelligent Qos decisions about when and how frequent to retry. Generally, a multi-tenant system allows multiple users to share a single hardware accelerator or device. A tenant can be an individual user, but may also include a group of users, such as a customer organization, that shares common access to and privileges to the hardware accelerator or device. For example, a tenant may include a virtual machine (VM), a container, and/or a software application. One goal of ACRE is to offload those complexities to hardware agent(s) to provide a cleaner and more simplified software interface.

Second, a software communication channel requires extensive CPU cycles which could have been used for other valuable work. For example, a minimal implementation (with very poor system throughput) may cost approximately eight CPU cycles per request sent, but a full implementation could cost more than 40 CPU cycles.

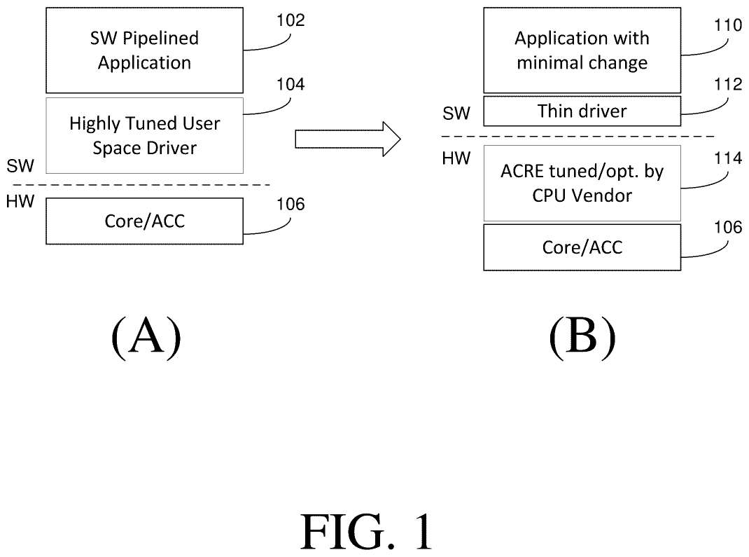

FIG. 1 illustrates a comparative block diagram of communication models in accordance with some embodiments. As shown on the left side of FIG. 1(A), some existing communication models may involve software changing and maintaining tasks, including a software (SW) pipelined application 102, a highly tuned user space driver 104 running on a processor core and/or accelerator (ACC) 106 hardware (HW). In an embodiment (see, e.g., the right side of FIG. 1(B)), the proposed ACRE enables an application with minimal change 110, a thin driver 112 with channels efficiently maintained in hardware using an ACRE circuitry 114, which may be tuned or optimized (e.g., by a CPU vendor).

One embodiment proposes a hardware agent to address the above-mentioned issues. In addition to saving the software overhead, development efforts for software implementation are reduced by using on-chip hardware accelerator(s), e.g., exposing less hardware specification details to software. In general, a hardware-based approach makes software more robust to hardware bugs, e.g., ensuring low software maintenance across different products.

In an embodiment, ACRE logic includes a hardware Intellectual Property (IP) block plus software co-design to offload the following communication tasks from software: (1) shared ring buffer management; (2) a dynamic batching algorithm and MMIO write of batch descriptor; (3) a notification-based result querying method with cache line prefetching and demotion; and/or (4) a QoS algorithm in a multi-tenant environment.

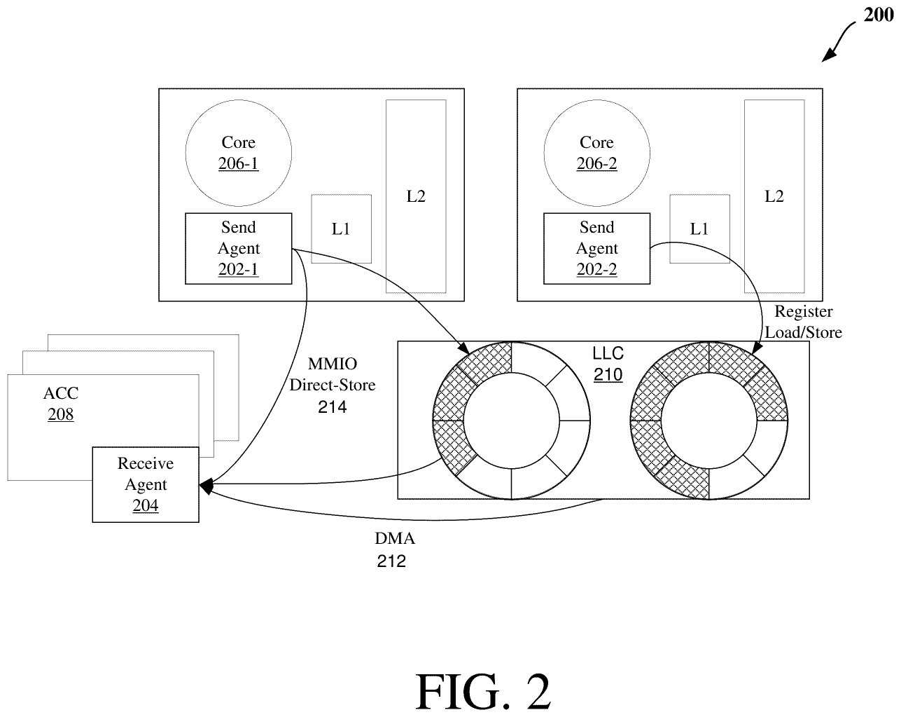

FIG. 2 illustrates a block diagram of a core to accelerator communication architecture 200, according to an embodiment. One or more operations of the core to accelerator communication architecture (also sometimes referred to herein as “ACRE”) may be performed by ACRE circuitry 114.

More particularly, ACRE circuitry 114 may be capable of addressing the issues of existing software-based communication models by providing one or more send agents (where two send agents 202-1 and 202-2 are shown in FIG. 2 for simplicity) and a receive agent 204. These agents can be used to set up communication channels between one or more processor cores (e.g., cores 206-1 and/or 206-2) and one or more accelerators 208. These agents (instead of software) would manage the communication channels, reducing software overhead of queue maintenance. In at least one embodiment, an agent dynamically batches requests by detecting streaming workload(s), to trade off between latency and throughput. The agent may demote and/or prefetches cache lines between a core's local cache (such as Level 1 (L1) cache or Level 2 (L2) cache) and a Last Level Cache (LLC) 210 shared between cores 206-1/206-2 to reduce cache line bouncing overhead. In an embodiment, the receive agent 204 (e.g., with monitoring logic) can perform rate limiting tasks for QoS in multi-tenant environments. As shown in FIG. 2, the send agents 202-1/202-2 and receive agent 204 may communicate through shared memory (LLC 210) and direct MMIO store 214. While an LLC 210 may be used as shared memory to communicate between the agents, other types of memory devices (or combination of memory devices) accessible by the send agent(s) and receive agent(s) may be used to share data as well; hence, embodiments are not limited to using an LLC.

In an embodiment, ACRE includes two hardware components, the sending agent(s) on the sender side (e.g., a processor core), and the receiving agent on the receiver side (e.g., accelerator). The sending agent may act as a proxy of the sender to communicate with the receiving agent by creating a ring-based communication channel in memory. The receiving agent acts as a proxy for a receiver, buffering incoming requests in its internal buffer. It also helps maintain tenant QoS and tracks completion results. In at least one embodiment of some accelerator designs (such as DSA provided by Intel Corporation of Santa Clara, California), the job descriptor-based communication model may be followed, where each acceleration job or task is described by a (e.g., 64-Byte) job descriptor. These job descriptors are passed through the communication channel(s) either by the shared ring buffer in memory (e.g., as shown in LLC 210) for an accelerator to read (e.g., using a Direct Memory Access (DMA) operation 212, or by a direct MMIO operation 214 directed at the receiving agent).

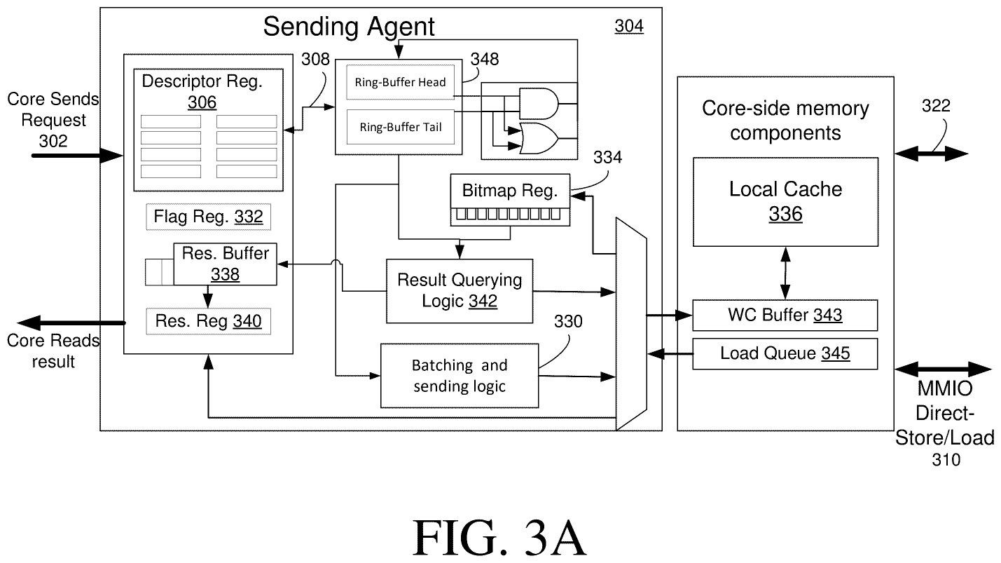

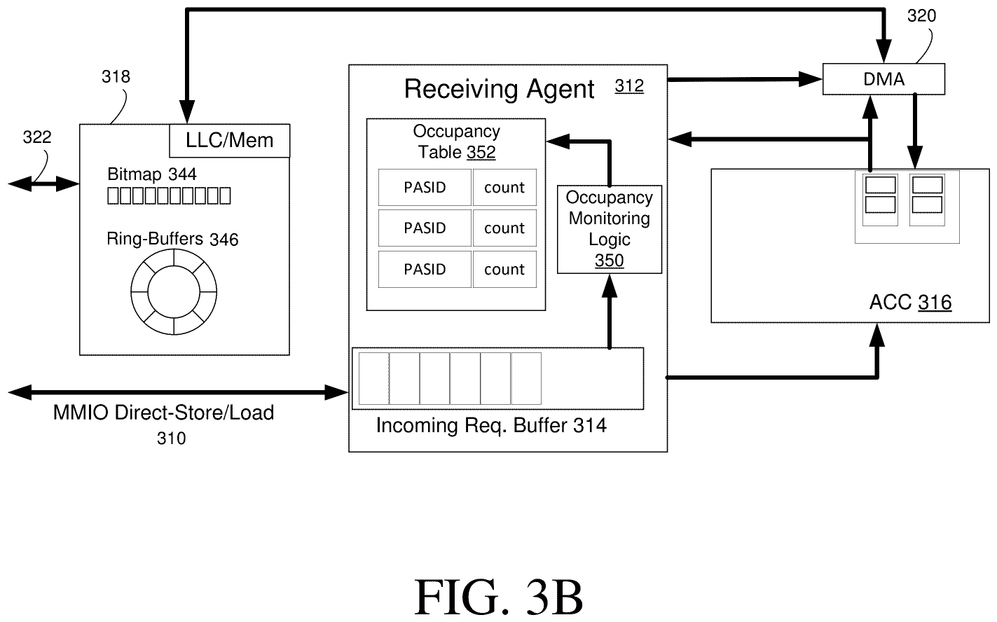

FIGS. 3A and 3B illustrate block diagrams of a hardware architecture for core to accelerator communication architecture, according to some embodiments. One or more operations of the core to accelerator communication architecture (also sometimes referred to herein as “ACRE”) may be performed by ACRE circuitry 114.

Referring to FIGS. 3A and 3B, the high-level workflow of ACRE circuitry for sending a batch of acceleration job requests can be described as follows. First, software (e.g., via a processor core) sends a request 302 by writing the job descriptor into the sending agent's (304) internal registers (labeled as descriptor registers 306). The sending agent 304 then uses weakly ordered stores to store the descriptor into the shared ring buffer 346 in memory 318. After accumulating a select number of job descriptors (e.g., as determined by comparison of the number of stored job descriptors against a threshold value), sending agent 304 (e.g., using a MMIO write operation) writes 310 a batch descriptor into the receiving agent's 312 MMIO queue 314. This MMIO write operation can be done using either a regular write or an AIA instruction. This MMIO write operation serves as a notification to the receiving agent 312 on the readiness of the batch of descriptors. Sending agent 304 may use the result querying logic 342 to query the result of the acceleration job. Sending agent may write descriptors to the write combining buffer (WC buffer 343) instead of directly writing to memory to improve performance. Sending agent 304 may also read data from memory 318 using the load queue 345 of a CPU core.

If the batch descriptor is accepted, the batch descriptor is buffered in the receiving agent's incoming request buffer 314 for further processing by an accelerator 316. The batch descriptor may be rejected by the receiving agent 312 due to a rate limit violation in some embodiments. Later, the accelerator 316 reads the batch descriptor from the receiving agent 312 and reads single job descriptors from memory 318 using DMA engine 320. Alternatively, the sending agent may directly MMIO write 310 the single job descriptor to the receiving agent without using the shared ring buffer stored in the memory 318. The sending agent 330 may detect which method is suitable during runtime using a hardware-based batching algorithm, e.g., to decide whether to batch or not to batch operations. The mechanism may be compatible with any accelerator, and it could work for accelerator-to-accelerator communication as well, enabling a universal communication interface. The receiving agent may use occupancy monitoring logic (350) together with the occupancy table 352 to monitor incoming queue (e.g., in incoming req. buffer 314) occupancy of each tenant on the platform. By monitoring the occupancy, an algorithm based on the occupancy can be designed to realize QoS feature such as rate limiting. For example, if one tenant has a high queue occupancy, the receiving agent may reject the tenant's request more often to give more resource to other tenants. As will be further discussed below, the algorithm based on the occupancy sets a threshold value, and when the request count from one PASID is above the threshold, a retry signal is sent. In an embodiment, requests from the PASID that are above a certain threshold (as determined at operation 458 discussed below) will be returned with a “retry” signal at operation 460. Otherwise, the descriptor is buffered in the hardware buffer for accelerator to pick up later at operation 462.

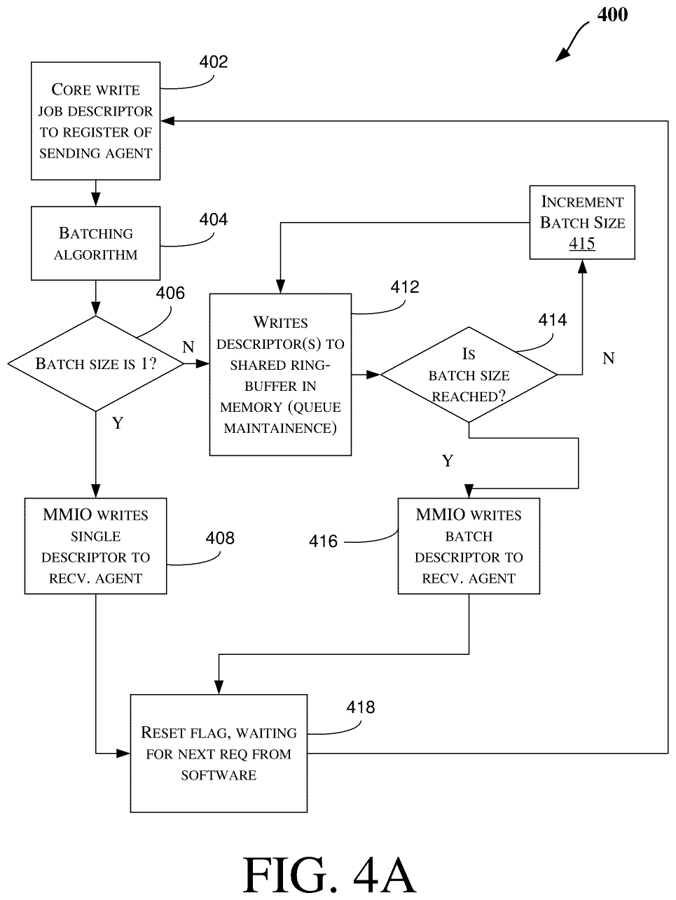

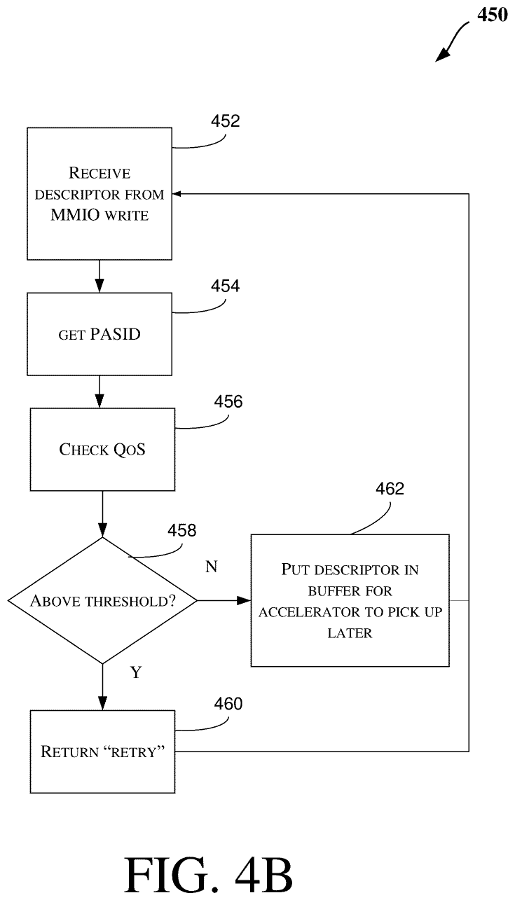

FIG. 4A illustrates a flow diagram of a method 400 for sending agent operations, according to an embodiment. FIG. 4B illustrates a flow diagram of a method 450 for receiving agent operations, according to one embodiment. One or more operations of methods 400 and/or 450 may be performed by the components of FIGS. 3A and 3B.

In an embodiment, the sending agent is relatively small hardware circuitry that is located near a processor core. The sending agent may reuse the core's memory execution units such as page miss handler, load-store queue, and write combining (WC) buffer to access memory. The sending agent may include the control logic and multiple internal registers to manage the communication channel between the sender and the receiver. There may also be registers used by the core to directly write job descriptors or read results from an agent. Among the internal registers, the Descriptor Registers are 8×8 Byte registers used by software to write a job descriptor into in an embodiment. Each job descriptor is a 64 Byte cache line that consists of the description of the acceleration job in one embodiment. For examples of a job descriptor format, one could refer to DSA's job descriptor format.

Referring to FIGS. 3A-4B, at an operation 402, the core writes a job descriptor to a register of the sending agent (such as the descriptor register 306). At an operation 404, a batching algorithm is invoked (e.g., performed by batching and sending logic 330). In one mode, the sending agent automatically detects if batching is needed and how large of a batch should be used. Although batching is usually preferable in a streaming workload, batching could introduce longer queueing latency for requests coming earlier into the queue. A simple heuristic-based algorithm implemented in the sending agent can be described as follows: the sending agent starts with a target batch size of 1. In every time window (e.g., 1 millisecond (ms)), one of the following conditions happening may result in doubling the batch size: 1) the number of requests per second is above a threshold, and 2) an excessive number of “retry” signals is sent from the receiving agent. Condition 1) implies the software is a streaming workload. Batching usually reduces uncore pressure and promotes throughput in streaming cases. Condition 2) indicates that the receiving agent cannot accept more requests due to some reason (e.g., high pressure, QoS reason, etc.). Batching and buffering requests in the shared ring buffer can reduce the pressure from the receiving agent. The batching size is halved if neither condition happens during the time window. Other algorithms based on hardware Performance Monitoring Counters can also be used in some embodiments. Moreover, CPU vendors could have a proprietary algorithm implemented and shipped to the customer without exposing the proprietary algorithm to software.

At operation 406, it is determined whether the batch size is 1. If so, at operations 408, a MIMO write operation 310 writes a single descriptor to the receiving agent's incoming request buffer 314. If the batch size is not 1, at operation 412, the descriptors are written 322 to the shared ring buffer in the memory 318. Operation 414 determines whether the batch size has reached a threshold value and if so, operation 416 MIMO writes the batch descriptors to the receiving agent's incoming buffer 314. If the batch size has not been reached at operation 414, operation 415 increments the batch size and method 400 resumes at operation 412. If the batch size is reached at operation 414, operation 416 is performed to MMIO write the batch descriptor to the receiving agent, and method 400 continues at operation 418. Operation 418 resets the flag and waits for the next request from software. After operation 418, method 400 resumes at operation 402.

In some embodiments, software first checks a vacant flag from the flag register 332 to determine whether the descriptor registers 306 are ready to be written to. Software then uses move (e.g., MOV) instructions to fill up the (e.g., eight) descriptor registers and resets the vacant flag (which may be performed prior to operation 402, e.g., assuming that the core has already checked the availability before entering operation 402; otherwise software waits until availability is confirmed before proceeding with operation 402). The sending agent then uses weakly ordered stores to write the descriptor to the head of the ring-buffer allocated in the memory. After writing, the queue head register is incremented by one to indicate the occupancy of the queue entry. As a circular ring, the head may wrap around if the value is larger than the queue depth. Once a select number of requests are queued (at operation 414), the sending agent MMIO writes a batch descriptor to the receiving agent's MMIO port (at operation 416). This MMIO write operation is done using direct store, such as MOVDIR or ENQCMD instructions, or using regular MMIO writes. The sending agent may also maintain a completion bitmap in its internal register 334. The bitmap may be in a coherent domain and monitor Require-for-ownership (RFO) signals sent during operation of a coherence protocol. Every change to the bitmap indicates that new results have been written to memory by the accelerator. In one embodiment, the result is wrapped in a 32 Byte Completion Record (CR). The sending agent prefetches the completion record into a local cache 336 for future use by at least one core, and stores the addresses of the CR in its internal result buffer 338 registers, and writes the first available CR address to the result register 340. If the buffer 338 is empty, the result register 340 is set to value zero (NULL pointer).

Referring to FIGS. 3B and 4B, the receiving agent 312 on the accelerator side contains a hardware incoming request buffer 314 to buffer incoming requests which are received at operation 452. This hardware incoming request buffer is different from the shared ring data structure in memory 318. Incoming requests sent 310 from the sending agent are temporarily buffered in this internal buffer before being picked up by the accelerator 316. If the incoming request is a batch job descriptor, the accelerator DMA engine 320 reads the single job descriptors from the shared ring structure in memory 318. Receiving agent is responsible for two tasks. First, the receiving agent monitors the queue occupancy (e.g., occupancy monitoring logic 350 is monitoring the occupancy in table 352) of the incoming request buffer 314 and keeping record of the traffic from each Process Address Space Identifier (PASID) at operation 454. This can be used to enable the QoS feature at operation 456. Requests from the PASID that are above a certain threshold (as determined at operation 458) will be returned with a “retry” signal at operation 460. Otherwise, the descriptor is buffered in the hardware buffer for accelerator to pick up later at operation 462. Second, once the accelerator finishes processing each job and writing to the completion record, the accelerator notifies the receiving agent about the completion and the receiving agent updates a completion bitmap 344 in memory 318 to notify sending agent about job completion through the bitmap register 334. Since the bitmap is also kept in bitmap register 334 in the sending agent, operation of a coherence protocol updates the contents of bitmap register 334, thus notify the sending agent. The sending agent then prefetches the completion records into local cache 336 and buffers the address of the completion record in its internal register (e.g., buffer 338, where the address is first buffered in the buffer 338 and the head of the buffer 338 is written to register 340) for software to pick up the result later.

Moreover, for the QoS algorithm, the receiving agent uses queue occupancy of the internal buffer (e.g., buffer 314) to regulate QoS for different processes. An internal occupancy table 352 mapping each PASID to a queue entry count is used to track the number of requests originating from each process. An extra counter for a number of total jobs can be used to track the total number of jobs queued in the incoming request buffer 314. A ratio set by user may be used to regulate the ratio of both counters. If the number of requests coming from a certain PASID is above the ratio threshold, a new request is returned with a “retry” signal at operation 460. Otherwise, the request is buffered in the internal buffer of the receiving agent and later picked by the accelerator at operation 462.

With respect to a notification-based result querying flow (e.g., performed by result querying logic 342 of FIG. 3A), once the accelerator 316 finishes a job, the accelerator notifies the receiving agent 312 on completion and the receiving agent writes a completion bitmap 344 to indicate which entry is done in the ring buffer 346. This bitmap 344 is pinned in the sending agent's local register file (e.g., bitmap register 334) in a coherence domain so that the sending agent will receive an RFO signal on the update. As discussed herein, a “coherence domain” generally refers to the data in the register being coherent with the cached data. This can cover CPU cache and internal registers of the agent and/or core. The sending agent then retrieves the bitmap 344 and checks which entries are finished. The sending agent prefetches the completion record of the finished request and buffers the address of the completion record in the internal buffer (e.g., 338 in FIG. 3A) of the sending agent. The completion record may be stored in any place in memory. In at least one embodiment, each request carries a pointer to a memory location to be as completion record. The accelerator will write the completion record, and CPU or software eventually needs to read the record. The completion record is the result of the request, which is completed by the accelerator. Software retrieves the address of the completion record from the internal register (e.g., register 340) of the sending agent.

In an embodiment, with respect to context switching, the sending agent 304 needs to context switch between multiple context values including the queue management values (e.g., tail, head 348), completion record addresses in Res. Buffer 338 that are waiting for core consumption, and the bitmap register 334 for completion request tracking. During a context switch, the values in the descriptor register 306 need to be flushed into memory. Register values that are related to the context need to be saved (e.g., using an XSAVE operation/instruction to save processor extended states) to memory for future reload.

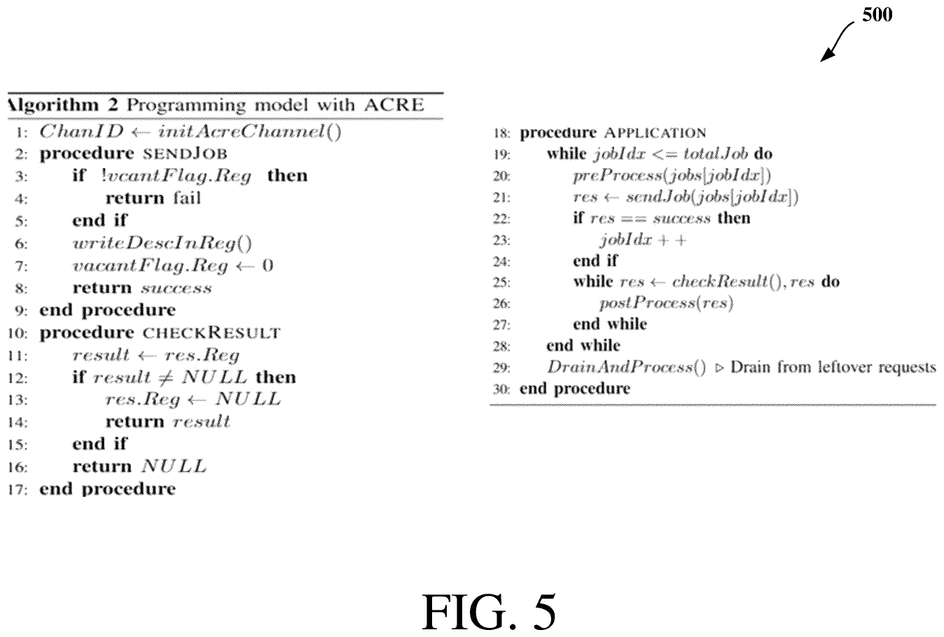

FIG. 5 illustrates a sample pseudo code 500 for implementing a core to accelerator communication architecture, according to an embodiment. Pseudo code 500 follows some of the operations discussed with reference to FIGS. 4A and 4B. As shown in FIG. 5, a channel identifier (ID) chanID is initialized first. A driver may implement sendJob ( ) and checkResult ( ) APIs. Application only calls these two API to communicate with an accelerator. In sendJob ( ) software only needs to write a single job descriptor to the sending agent's internal register (line 6). For checkResult ( ) software only needs to read the result from agent's internal register (line 11). Application call preProcess ( ) and PostProcess ( ) before and after sendJob and checkResult in loops for streaming workload. Both driver and application are relatively simple and easy to maintain. Queue management, batching, QoS related work may all be handled by ACRE hardware, simplifying maintenance and development effort from software, and also reducing CPU cycles spent on software implementation.

In some implementations, ACRE could improve system throughput by a factor of three to seven comparing to a system without ACRE. Dynamic instruction counts can also be significantly reduced due to the much simpler software interface.

Accordingly, at least one embodiment provides a hardware-based approach to realize a universal core-to-accelerator communication channel. A sending agent and a receiving agent are proposed to create and maintain a communication channel through a shared ring-buffer and MMIO direct store operations. The proposed hardware architecture unifies interfaces between core and various accelerators, and possibly between accelerator and accelerator. Initial evaluation results show significant CPU cycle savings, and much reduced programming effort.

Additionally, some embodiments may be applied in computing systems that include one or more processors (e.g., where the one or more processors may include one or more processor cores), such as those discussed with reference to FIGS. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU (Central Processing Unit) including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

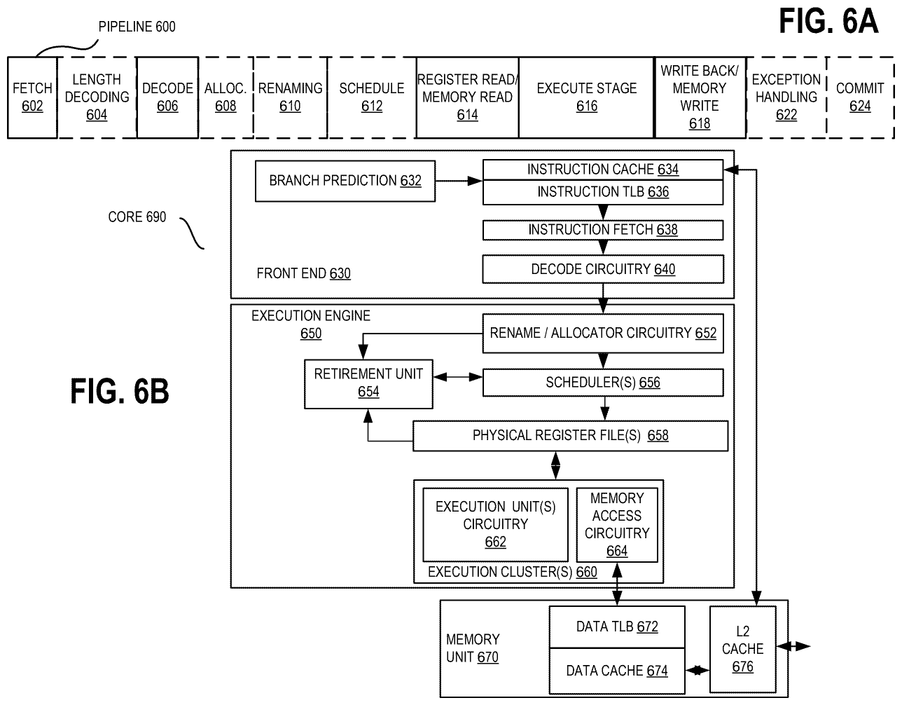

FIG. 6A is a block diagram illustrating both an exemplary in-order pipeline and an exemplary register renaming, out-of-order issue/execution pipeline according to embodiments. FIG. 6B is a block diagram illustrating both an exemplary embodiment of an in-order architecture core and an exemplary register renaming, out-of-order issue/execution architecture core to be included in a processor according to embodiments. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end unit 630 coupled to an execution engine unit 650, and both are coupled to a memory unit 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit 640 (or decoder) may decode instructions, and generate as an output one or more micro-operations, micro-code entry points, microinstructions, other instructions, or other control signals, which are decoded from, or which otherwise reflect, or are derived from, the original instructions. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front end unit 630). The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 658 comprises a vector registers unit, a writemask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 6) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, CA; the ARM instruction set (with optional additional extensions such as NEON) of ARM Holdings of Sunnyvale, CA), including the instruction(s) described herein. In one embodiment, the core 690 includes logic to support a packed data instruction set extension (e.g., AVX1, AVX2), thereby allowing the operations used by many multimedia applications to be performed using packed data.

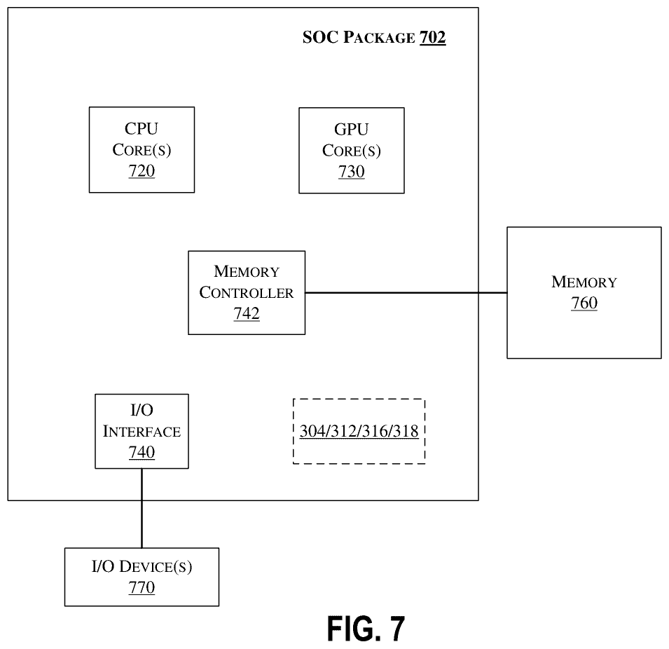

FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 702 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like.

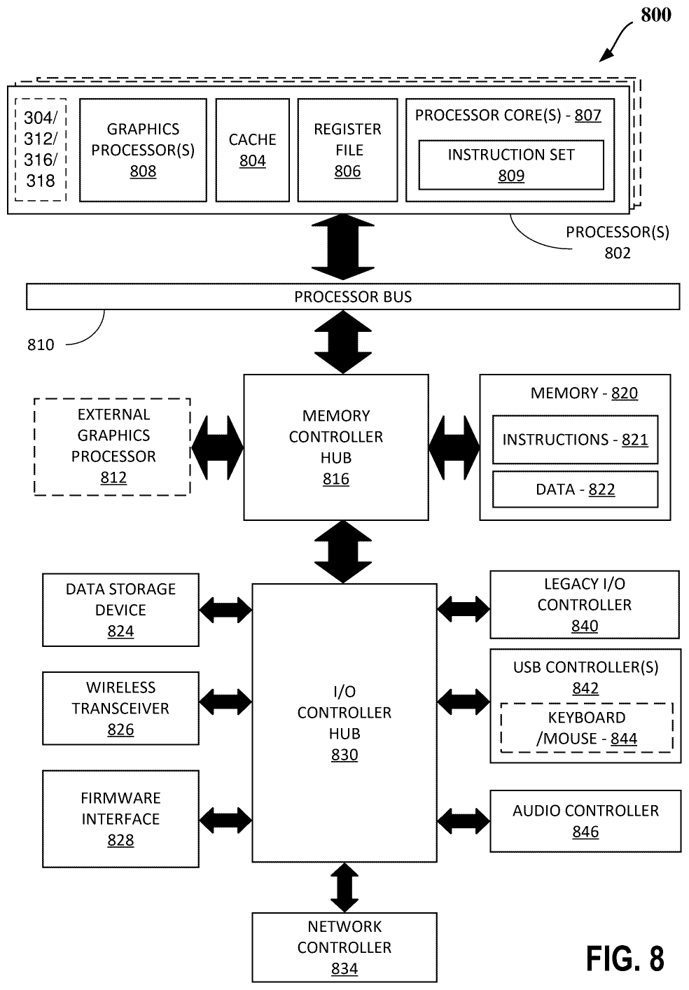

FIG. 8 is a block diagram of a processing system 800, according to an embodiment. In various embodiments the system 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 809. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, processor 802 is coupled to a processor bus 810 to transmit communication signals such as address, data, or control signals between processor 802 and other components in system 800. In one embodiment the system 800 uses an exemplary ‘hub’ system architecture, including a memory controller hub 816 and an Input Output (I/O) controller hub 830. A memory controller hub 816 facilitates communication between a memory device and other components of system 800, while an I/O Controller Hub (ICH) 830 provides connections to I/O devices via a local I/O bus. In one embodiment, the logic of the memory controller hub 816 is integrated within the processor.

Memory device 820 can be a dynamic random access memory (DRAM) device, a static random access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 executes an application or process. Memory controller hub 816 also couples with an optional external graphics processor 812, which may communicate with the one or more graphics processors 808 in processors 802 to perform graphics and media operations.

In some embodiments, ICH 830 enables peripherals to connect to memory device 820 and processor 802 via a high-speed I/O bus. The I/O peripherals include, but are not limited to, an audio controller 846, a firmware interface 828, a wireless transceiver 826 (e.g., Wi-Fi, Bluetooth), a data storage device 824 (e.g., hard disk drive, flash memory, etc.), and a legacy I/O controller 840 for coupling legacy (e.g., Personal System 2 (PS/2)) devices to the system. One or more Universal Serial Bus (USB) controllers 842 connect input devices, such as keyboard and mouse 844 combinations. A network controller 834 may also couple to ICH 830. In some embodiments, a high-performance network controller (not shown) couples to processor bus 810. It will be appreciated that the system 800 shown is exemplary and not limiting, as other types of data processing systems that are differently configured may also be used. For example, the I/O controller hub 830 may be integrated within the one or more processor 802, or the memory controller hub 816 and I/O controller hub 830 may be integrated into a discreet external graphics processor, such as the external graphics processor 812.

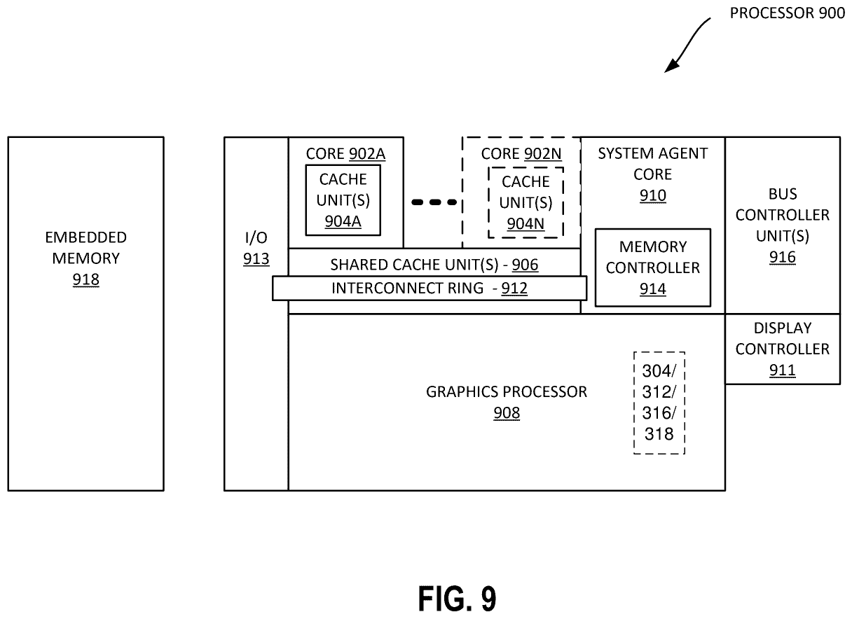

FIG. 9 is a block diagram of an embodiment of a processor 900 having one or more processor cores 902A to 902N, an integrated memory controller 914, and an integrated graphics processor 908. Those elements of FIG. 9 having the same reference numbers (or names) as the elements of any other figure herein can operate or function in any manner similar to that described elsewhere herein, but are not limited to such. Processor 900 can include additional cores up to and including additional core 902N represented by the dashed lined boxes. Each of processor cores 902A to 902N includes one or more internal cache units 904A to 904N. In some embodiments each processor core also has access to one or more shared cached units 906.

The internal cache units 904A to 904N and shared cache units 906 represent a cache memory hierarchy within the processor 900. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 906 and 904A to 904N.

In some embodiments, processor 900 may also include a set of one or more bus controller units 916 and a system agent core 910. The one or more bus controller units 916 manage a set of peripheral buses, such as one or more Peripheral Component Interconnect buses (e.g., PCI, PCI Express). System agent core 910 provides management functionality for the various processor components. In some embodiments, system agent core 910 includes one or more integrated memory controllers 914 to manage access to various external memory devices (not shown).

In some embodiments, one or more of the processor cores 902A to 902N include support for simultaneous multi-threading. In such embodiment, the system agent core 910 includes components for coordinating and operating cores 902A to 902N during multi-threaded processing. System agent core 910 may additionally include a power control unit (PCU), which includes logic and components to regulate the power state of processor cores 902A to 902N and graphics processor 908.

In some embodiments, processor 900 additionally includes graphics processor 908 to execute graphics processing operations. In some embodiments, the graphics processor 908 couples with the set of shared cache units 906, and the system agent core 910, including the one or more integrated memory controllers 914. In some embodiments, a display controller 911 is coupled with the graphics processor 908 to drive graphics processor output to one or more coupled displays. In some embodiments, display controller 911 may be a separate module coupled with the graphics processor via at least one interconnect, or may be integrated within the graphics processor 908 or system agent core 910.

In some embodiments, a ring based interconnect unit 912 is used to couple the internal components of the processor 900. However, an alternative interconnect unit may be used, such as a point-to-point interconnect, a switched interconnect, or other techniques, including techniques well known in the art. In some embodiments, graphics processor 908 couples with the ring interconnect 912 via an I/O link 913.

The exemplary I/O link 913 represents at least one of multiple varieties of I/O interconnects, including an on package I/O interconnect which facilitates communication between various processor components and a high-performance embedded memory module 918, such as an eDRAM (or embedded DRAM) module. In some embodiments, each of the processor cores 902 to 902N and graphics processor 908 use embedded memory modules 918 as a shared Last Level Cache.

In some embodiments, processor cores 902A to 902N are homogenous cores executing the same instruction set architecture. In another embodiment, processor cores 902A to 902N are heterogeneous in terms of instruction set architecture (ISA), where one or more of processor cores 902A to 902N execute a first instruction set, while at least one of the other cores executes a subset of the first instruction set or a different instruction set. In one embodiment processor cores 902A to 902N are heterogeneous in terms of microarchitecture, where one or more cores having a relatively higher power consumption couple with one or more power cores having a lower power consumption. Additionally, processor 900 can be implemented on one or more chips or as an SoC integrated circuit having the illustrated components, in addition to other components.

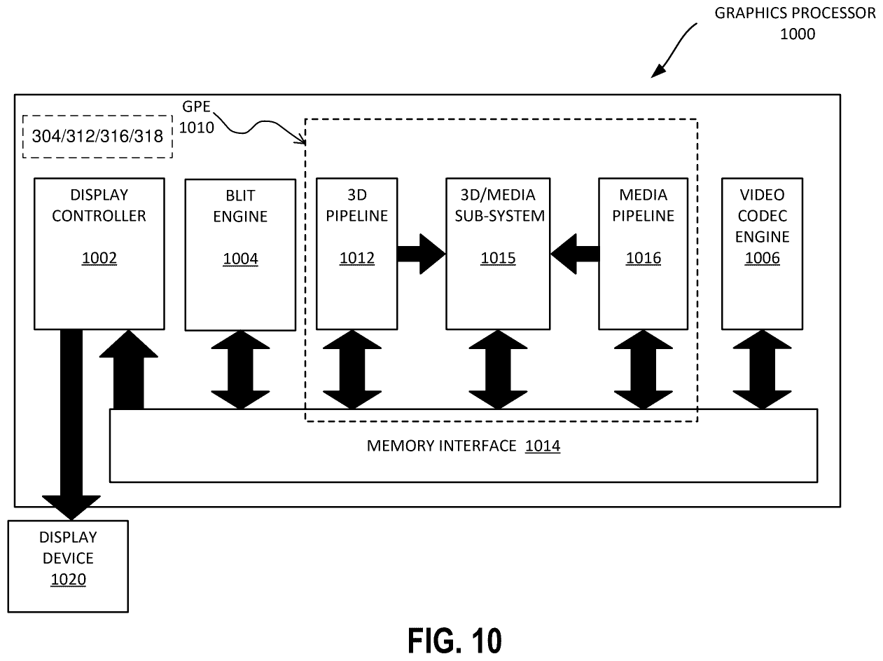

FIG. 10 is a block diagram of a graphics processor 1000, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1000 includes a memory interface 1014 to access memory. Memory interface 1014 can be an interface to local memory, one or more internal caches, one or more shared external caches, and/or to system memory.

In some embodiments, graphics processor 1000 also includes a display controller 1002 to drive display output data to a display device 1020. Display controller 1002 includes hardware for one or more overlay planes for the display and composition of multiple layers of video or user interface elements. In some embodiments, graphics processor 1000 includes a video codec engine 1006 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 1000 includes a block image transfer (BLIT) engine 1004 to perform two-dimensional (2D) rasterizer operations including, for example, bit-boundary block transfers. However, in one embodiment, 3D graphics operations are performed using one or more components of graphics processing engine (GPE) 1010. In some embodiments, graphics processing engine 1010 is a compute engine for performing graphics operations, including three-dimensional (3D) graphics operations and media operations.

In some embodiments, GPE 1010 includes a 3D pipeline 1012 for performing 3D operations, such as rendering three-dimensional images and scenes using processing functions that act upon 3D primitive shapes (e.g., rectangle, triangle, etc.). The 3D pipeline 1012 includes programmable and fixed function elements that perform various tasks within the element and/or spawn execution threads to a 3D/Media sub-system 1015. While 3D pipeline 1012 can be used to perform media operations, an embodiment of GPE 1010 also includes a media pipeline 1016 that is specifically used to perform media operations, such as video post-processing and image enhancement.

In some embodiments, media pipeline 1016 includes fixed function or programmable logic units to perform one or more specialized media operations, such as video decode acceleration, video de-interlacing, and video encode acceleration in place of, or on behalf of video codec engine 1006. In some embodiments, media pipeline 1016 additionally includes a thread spawning unit to spawn threads for execution on 3D/Media sub-system 1015. The spawned threads perform computations for the media operations on one or more graphics execution units included in 3D/Media sub-system 1015.

In some embodiments, 3D/Media subsystem 1015 includes logic for executing threads spawned by 3D pipeline 1012 and media pipeline 1016. In one embodiment, the pipelines send thread execution requests to 3D/Media subsystem 1015, which includes thread dispatch logic for arbitrating and dispatching the various requests to available thread execution resources. The execution resources include an array of graphics execution units to process the 3D and media threads. In some embodiments, 3D/Media subsystem 1015 includes one or more internal caches for thread instructions and data. In some embodiments, the subsystem also includes shared memory, including registers and addressable memory, to share data between threads and to store output data.

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes 1 includes an apparatus comprising: a sending agent coupled to a processor core; a receiving agent coupled to a hardware accelerator device; and a memory to store data corresponding to a request from the processor core, wherein the sending agent and the receiving agent are to maintain a communication channel to facilitate communication between the processor core and the hardware accelerator device in response to the request. Example 2 includes the apparatus of example 1, wherein the memory is to store a ring buffer to be shared by the sending agent and the receiving agent. Example 3 includes the apparatus of example 2, wherein the ring buffer is to provide the communication channel. Example 4 includes the apparatus of example 1, wherein one of the sending agent and the receiving agent is to generate the communication channel. Example 5 includes the apparatus of example 1, wherein the memory comprises a Last Level Cache (LLC). Example 6 includes the apparatus of example 1, wherein the receiving agent is to buffer incoming requests from the processor core in a buffer. Example 7 includes the apparatus of example 6, wherein the buffer is to be accessed via a Memory Mapped Input/Output (MMIO) load operation or a MMIO store operation. Example 8 includes the apparatus of example 1, wherein the request corresponds to a job to be performed by the hardware accelerator device. Example 9 includes the apparatus of example 8, wherein a job descriptor, corresponding to the job, is to be communicated through the communication channel. Example 10 includes the apparatus of example 9, wherein the job descriptor is to be communicated to the hardware accelerator device through a Direct Memory Access (DMA) operation. Example 11 includes the apparatus of example 1, wherein the receiving agent is to utilize occupancy data to regulate Quality of Service (QOS) for different processes. Example 12 includes the apparatus of example 11, wherein the occupancy data is to be stored in a table that maps each Process Address Space Identifier (PASID) to a corresponding queue entry count. Example 13 includes the apparatus of example 1, wherein completion of the requests are to be signaled through a completion bitmap. Example 14 includes the apparatus of example 13, wherein the completion bitmap is to be stored in the memory or a register. Example 15 includes the apparatus of example 13, wherein the completion bitmap is in a coherent domain.

Example 16 includes one or more non-transitory computer-readable media comprising one or more instructions that when executed on a processor configure the processor to perform one or more operations to cause: a sending agent, coupled to a processor core, and a receiving agent, coupled to a hardware accelerator device to maintain a communication channel to facilitate communication between the processor core and the hardware accelerator device in response to a request from the processor core; and memory to store data corresponding to the request from the processor core. Example 17 includes the one or more computer-readable media of example 16, further comprising one or more instructions that when executed on the at least one processor configure the at least one processor to perform one or more operations to cause the memory to store a ring buffer to be shared by the sending agent and the receiving agent. Example 18 includes the one or more computer-readable media of example 17, further comprising one or more instructions that when executed on the at least one processor configure the at least one processor to perform one or more operations to cause the ring buffer to provide the communication channel. Example 19 includes the one or more computer-readable media of example 16, further comprising one or more instructions that when executed on the at least one processor configure the at least one processor to perform one or more operations to cause one of the sending agent and the receiving agent to generate the communication channel. Example 20 includes the one or more computer-readable media of example 16, wherein the memory comprises a Last Level Cache (LLC). Example 21 includes the one or more computer-readable media of example 16, further comprising one or more instructions that when executed on the at least one processor configure the at least one processor to perform one or more operations to cause the receiving agent to buffer incoming requests from the processor core in a buffer. Example 22 includes the one or more computer-readable media of example 21, further comprising one or more instructions that when executed on the at least one processor configure the at least one processor to perform one or more operations to cause the buffer to be accessed via a Memory Mapped Input/Output (MMIO) load operation or a MMIO store operation. Example 23 includes the one or more computer-readable media of example 16, wherein the request corresponds to a job to be performed by the hardware accelerator device. Example 24 includes the one or more computer-readable media of example 16, further comprising one or more instructions that when executed on the at least one processor configure the at least one processor to perform one or more operations to cause the receiving agent to utilize occupancy data to regulate Quality of Service (QOS) for different processes. Example 25 includes the one or more computer-readable media of example 16, further comprising one or more instructions that when executed on the at least one processor configure the at least one processor to perform one or more operations to cause completion of the request to be signaled through a completion bitmap.

Example 26 includes a method comprising: a sending agent, coupled to a processor core, and a receiving agent, coupled to a hardware accelerator device, maintaining a communication channel to facilitate communication between the processor core and the hardware accelerator device in response to a request from the processor core; and storing data corresponding to the request from the processor core in memory. Example 27 includes the method of example 26, further comprising causing the memory to store a ring buffer to be shared by the sending agent and the receiving agent. Example 28 includes the method of example 27, further comprising causing the ring buffer to provide the communication channel. Example 29 includes the method of example 26, further comprising causing one of the sending agent and the receiving agent to generate the communication channel. Example 30 includes the method of example 26, wherein the memory comprises a Last Level Cache (LLC).

Example 31 includes an apparatus comprising means to perform a method as set forth in any preceding example. Example 32 includes machine-readable storage including machine-readable instructions, when executed, to implement a method or realize an apparatus as set forth in any preceding example.

In various embodiments, one or more operations discussed with reference to FIGS. 1 et seq. may be performed by one or more components (interchangeably referred to herein as “logic”) discussed with reference to any of the figures.

In various embodiments, the operations discussed herein, e.g., with reference to FIGS. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-30. (canceled)

31. An apparatus comprising:
a sending agent coupled to a processor core;
a receiving agent coupled to a hardware accelerator device; and
a memory to store data corresponding to a request from the processor core,
wherein the sending agent and the receiving agent are to maintain a communication channel to facilitate communication between the processor core and the hardware accelerator device in response to the request.

32. The apparatus of claim 31, wherein the memory is to store a ring buffer to be shared by the sending agent and the receiving agent.

33. The apparatus of claim 32, wherein the ring buffer is to provide the communication channel.

34. The apparatus of claim 31, wherein one of the sending agent and the receiving agent is to generate the communication channel.

35. The apparatus of claim 31, wherein the memory comprises a Last Level Cache (LLC).

36. The apparatus of claim 31, wherein the receiving agent is to buffer incoming requests from the processor core in a buffer.

37. The apparatus of claim 36, wherein the buffer is to be accessed via a Memory Mapped Input/Output (MMIO) load operation or a MMIO store operation.

38. The apparatus of claim 31, wherein the request corresponds to a job to be performed by the hardware accelerator device.

39. The apparatus of claim 38, wherein a job descriptor, corresponding to the job, is to be communicated through the communication channel.

40. The apparatus of claim 39, wherein the job descriptor is to be communicated to the hardware accelerator device through a Direct Memory Access (DMA) operation.

41. The apparatus of claim 31, wherein the receiving agent is to utilize occupancy data to regulate Quality of Service (QOS) for different processes.

42. The apparatus of claim 41, wherein the occupancy data is to be stored in a table that maps each Process Address Space Identifier (PASID) to a corresponding queue entry count.

43. The apparatus of claim 31, wherein completion of the requests are to be signaled through a completion bitmap.

44. The apparatus of claim 43, wherein the completion bitmap is to be stored in the memory or a register.

45. The apparatus of claim 43, wherein the completion bitmap is in a coherent domain.

46. One or more non-transitory computer-readable media comprising one or more instructions that when executed on a processor configure the processor to perform one or more operations to cause:
a sending agent, coupled to a processor core, and a receiving agent, coupled to a hardware accelerator device to maintain a communication channel to facilitate communication between the processor core and the hardware accelerator device in response to a request from the processor core; and
memory to store data corresponding to the request from the processor core.

47. The one or more computer-readable media of claim 46, further comprising one or more instructions that when executed on the at least one processor configure the at least one processor to perform one or more operations to cause the memory to store a ring buffer to be shared by the sending agent and the receiving agent.

48. The one or more computer-readable media of claim 47, further comprising one or more instructions that when executed on the at least one processor configure the at least one processor to perform one or more operations to cause the ring buffer to provide the communication channel.

49. The one or more computer-readable media of claim 46, further comprising one or more instructions that when executed on the at least one processor configure the at least one processor to perform one or more operations to cause one of the sending agent and the receiving agent to generate the communication channel.

50. The one or more computer-readable media of claim 46, wherein the memory comprises a Last Level Cache (LLC).
